(19) United States
(12) Patent Application Publication
(10) Pub. No.: US 2023/0157303 A1
(43) Pub. Date: May 25, 2023

(54) Plant-Based Pesticide

(71) Applicant: Miah Muhammad Adel, Pine Bluff, AR (US)

(72) Inventor: Miah Muhammad Adel, Pine Bluff, AR (US)

(21) Appl. No.: 17/994,059

(22) Filed: Nov. 25, 2022

(51) Int. Cl. A01N 65/34; A01P 7/04; A01P 17/00

(52) U.S. Cl. CPC A01N 65/34; A01P 7/04; A01P 17/00

(57) ABSTRACT

Cucurbitaceae family snake gourd (Trichosanthes anguina L.), grown in many Asian countries and Southern US States; characteristic aroma, green, tender stems, forked tendrils, heart-shaped shaped or palmately broad leaves; long lacy fringed, five-petalled, day-night open, white unisexual flowers; multifarious health benefiting fruits; resists major fungal, bacterial, and viral diseases, repels aphids, insects, and beetles (Cerotoma trifurcata) from pumpkin, squash, and bean plants if interposed among the target vines (U.S. patent application Ser. No. 17/942,119); claimed commercial use of the intensely aromatic distinct variety of Trichosanthes cucumerina summer plant extract/oil or synthetically prepared the same aromatic product for uniformly spraying upon the target vines and testing on other target fruit vines, fruit plants, and fruit trees, and vegetable plants throughout the year; potential replacement for bee-killing, water resources polluting, human, aquatics, and wildlife infecting chemical pesticides like Sevin, Malathion, Diazinon, and Neonicotinoids (Neonics), and replacement for manually killing of pests.

### BACKGROUND OF THE INVENTION

Cucurbitaceae family snake gourd (Trichosanthes anguina L.), (FIGS. 1 and 2, and FIGS. 7 through 10) grown in many Asian countries and Southern US States; characteristic aroma, green, tender stems, forked tendrils, heart-shaped shaped or palmately broad leaves; long lacy fringed, five-petalled, day-night open, white unisexual flowers; multifarious health benefiting fruits; resists major fungal, bacterial, viral diseases, repels aphids, insects, and beetles (Cerotoma trifurcata) from pumpkin, squash, and bean vines if the said vine is interposed among these target vines (U.S. patent application Ser. No. 17/942,119); claimed commercial use of the characteristic aroma-containing plant extract/oil as well as synthetically prepared the same aromatic product for uniformly spraying upon the target plants and on other potential target fruit vines, fruit trees, and vegetable plants throughout the year; primary objectives avoidance of water resources pollution, aquatics and wildlife infection, human endangerment, and bee population killing by the use of chemical pesticides like sevin, malathion, diazinon, neonicotinoids (Neonics) for gardens growing pumpkin, squash, and beans, to avoid manually killing of pests, and to test on other potential target fruit vines (viz., grapes), fruit trees (viz., apple, plum, peach, cherry etc.), fruit plants (viz., egg plants, tomato plants, etc.) and vegetable plants (viz., cabbage, cauli flower, broccoli, red leafy vegetable, celeries, etc.) throughout the year by uniformly spraying the intensely aromatic distinct variety of Trichosanthes cucumerina plant oil/extract as well as synthetically prepared the same aromatic product.

While the use of pesticides has resulted in increased food production and decreased insect-borne diseases, it has adversely affected the environment, particularly the bee population and the water quality. The discovery relates (i) to less pesticide production, and thus saves energy and time, (ii) to protection of water bodies and streams, the aquatics therein, and the aquatics-fed wildlife, (iii) to the bee population against harmful pesticide use, and (iv) to the yield of healthy vine fruits. Further, as the said vine leaf remains unaffected by major fungal, bacterial, and viral diseases, and by aphids, insects, and beetles (Cerotoma trifurcata) due to the leaf and fruit aroma, the leaf and fruit oil/extract spray will drive away the same nuisance from these targeted vines and other vines and fruit trees.

The USA uses annually more than one-half billion kg (more than one billion lbs.) of pesticides. The fruit and vegetable growers use the lions share of pesticides per acre. The following table is an estimate of manufacturing energy inputs for various pesticides in BTUs/lb, typical application rates in lbs/A, and energy per unit area of use in BTUs/A on an active ingredient basis (https://farm-energy.extension.org/energy-use-and-efficiency-in-pest-control-including-pesticide-production-use-and-management-options/).

TABLE 1
Energy costs in various pesticides manufacturing

| | Pesticide | | |
|---|---|---|---|
| | BTUd/lb × | Application Rate | BTUs/A × |
| Insecticides | (1000) | (lbs/A) | (1000) |
| Carbaryl | 65.8 | 1.50 | 32.9 |
| Cypermethrin | 249.4 | 0.25 | 62.4 |
| Malathion | 98.5 | 1.25 | 123.1 |
| Phorate | 89.9 | 2.50 | 224.8 |

Active ingredient in sevin is carbaryl which belongs to a class of insecticides called carbamates. Carbaryl stays on the surface of plants and soil. Carbaryl affects nervous-system, reproductive systems, and can cause cancer (https://oehha.ca.gov/media/downloads/pesticides/fact-sheet/hgasevingamarch2016final.pdf). Runoff can mix it from plant surface and soil surface to streams and groundwater. Sevin is banned in the United Kingdom, Denmark, Australia, Germany, Sweden, Iran and Angola. It is carcinogenic. Its continuous inhalation can cause pneumoconiosis which is associated with hardening of the air sacs in the lungs caused from inflammation. Complicated pneumoconiosis can cause heart failure, lung cancer, respiratory failure. Sevin dust can cause fetal abnormalities like cardio and pulmonary, nervous system development, spontaneous abortion, inattention, distractibility, and poor working memory in children and a host of other difficulties (https://foodtruthfreedom.wordpress.com/2013/01/28/sevin-dust-illegal-in-many-countries-top-seller-in-u-s/).

Cypermethrin is a synthetic pyrethroid, a chemicals that kill insects, including mosquitoes. It is highly toxic to aquatic wildlife, very highly toxic to honeybees (not to be applied on blooming plants), acutely toxic to humans and other mammals (http://ipm.ucanr.edu/TOOLS/PNAI/pnaishow.php?id=118#EXAMPLE)

Malathion is an organophosphate insecticide commonly used to control mosquitoes and a variety of fruit, vegetable, and shrub insects Because pesticide products are inherently toxic, no pesticide exposure is risk free. Short- to long-term exposures to high levels of malathion can cause headaches, nausea, dizziness, weakness, cramps, diarrhea, excessive sweating, blurred vision and increased heart rate, skin rash (https://www.health.ny.gov/publications/2740/#:˜:text=Short%2Dterm%20exposures%20to%20 high, vision%20and%20increased%20heart%20rate).

Diazinon is an organophosphorus pesticide used to control pest insects in soil and on fruit and vegetable field crops. Diazinon exposure from ingestion, skin contact, or inhalation can result in watery eyes, runny nose, drooling, loss of appetite, coughing, urination, diarrhea, stomach pain, and vomiting. Larger exposures result in head and body tremors, muscle spasms or stiffness, muscle weakness or paralysis, rapid heart rate, difficulty breathing, seizures, convulsions, or coma (http://npic.orst.edu/factsheets/Diazgen.html#:˜text=Diazinon%20exposure%2C%20whether%2 0from%20ingestion.%2C%20stomach%20pain%2C%20and%20vomiting).

Neonicotinoids are popularly used in agricultural and commercial ornamental production to guard against a wide range of insect pests. In 2014, the European Food Safety Commission (EFSA) found that the neonicotinoid pesticides (acetamiprid and imidacloprid) cause bee deaths and harmful to humans. The normal development and function of the nervous system in children is obstructed by Acetamiprid (ACE) and imidacloprid (IMI). These damage brain structures and functions associated with learning and memory (https://waterskraus.com/neonicotinoid-pesticides-people-risk/).

These pesticides are used in growing pumpkin, squash, and beans as mentioned below. Some recommend these pesticides for use in extreme cases.

Khan and Jehangir (2000) discuss the efficacy of Sevin, and Hasan et al. (2011) discuss the efficacy of Malathion in killing pumpkin beetles. UC Pest Management Guidelines recommend neonicitinoid class dinotefuran lambda cyhalothrin, esfenvelerate, and pyrethrin for squash bugs (http://ipm.ocanr.edu/PMG/r116301111.html). Pumpkin and squash bugs make holes in leaves, and Hyacinth (Dolichos Lablab Purpureus) bug makes holes in leaves and the beans. Also, aphids attack these plants. Aphids suck sap from various plants, and they grow to build colonies. Smart Gardener suggested remedies are pyrethrum and Bacillus thuringiensis (Bt) for extreme cases (https://www.smartgardner.com/plants/6865-bean-specialty-hyacinth-lablab-purpureus/pests/538-aphidaFIG). Gill and Raine (2014) reports that sevin, malathion, diazinon, and neonicotinoids (neonics) are toxic for honeybees. Stockpoole (2017) discusses pesticides accumulation in streams and water bodies from where they can enter aquatic organisms, making them risky for human consumption.

In 2019, the USA produced 6.9 million cwt (cwt stands for hundred weight=total # of lbs./100) squash that had a value of $149 million. Out of planting in 45,000 acres, 43,500 acres were harvested. In 2016, the squash yield was 1,615 cwt per acre. California is the leading state in squash production. The state is followed by Florida, Georgia, and Michigan. The United States annually imports 300,000 MT (metric ton−2,000 lbs.=907.18 kg) of squash In In 2020, squash imports rose to $507 million. Mexico is a 93.2 percent supplier of the squash imports to the United States. (https:www.agmrc.org/commodities-products/vegetables/squash#:˜:text=Squash%20had%20an%20averave%20of,dense%20orange %20or%20yellow%20flesh.).

Pumpkin and squash bugs skeletonize the tender plant leaves as shown in FIG. 20 below. The plant cannot bear fruit. Squash bugs can attack zucchini, cucumber, cantaloupe, and watermelon plants. Non-pesticide uses control of pumpkin and squash bugs (FIG. 24) (about ½ to 1 inch long, flat-backed, able to fly but walk) involves checking the underside of every leaves for the clusters of eggs they lay for destroying the eggs and manually killing the adults.

For nonuniformity of interposing the snake guard plant among pumpkin plants, it could not be proved if vine borers, the creatures that burrow deep into pumpkin vines and suck away their moisture, could be repelled by the snake guard vine extract/juice.

Hyacinth beans grow in purple, red, and white colors. Their pests are longtail skipper caterpillars, Japanese beetles. An aphid-attacked bean plants image is shown in FIG. 21. The pests make holes in the plant leaves (FIG. 15) and in the beans (FIG. 22).

The applicant, a physics professor and an avid gardener and a researcher discovered that only snake gourd vines remain unaffected by pests while pumpkin and bean vines are affected as point out above. He got gid of the problem of pests with pumpkin and bean vines by interposing the snake gourd vines in pumpkin and bean vines. Fresh, spotless, healthy pumpkin plants using snake gourd vines are shown in FIG. 18. Prior to this arrangement, the applicant used to manually kill the pumpkin bugs. FIG. 16 shows healthy bean plant and snake gourd plant growing together. Fresh hyacinth flat beans from the applicant's garden using the snake gourd repellant are shown in FIGS. 26 and 27. He already made a plant patent application for Trichosanthes cucumerina. The application #is Ser. No. 17/942,119. This time he is applying for a utility patent for Trichosanthes cucumerina extract/oil.

Apart from the applicant reported discoveries, snake gourd fruits, seeds, leaves, and juice extracts contain carbohydrates, fats, proteins, fibers, vitamin A, vitamin B6, vitamin C, vitamin E, minerals, phenolics and cucurbitacins (Bharat, 2022). Its medicinal effects promote weight loss, heart health, immunity. It has anti-fungal, anti-dandruff, and scalp nourishing effects.

### SUMMARY OF THE INVENTION

The applicant, a physics professor, has maintained his gardening hobby from his boyhood days. He produces different kinds of tropical fruits and vegetables. In his home garden, he finds that while other vines are attacked with pests, snake gourd vines are not. The distinction between the snake gourd and other vines lies in the snake gourd's intense aroma. Their leaves remain spotless. Tiny vines do not have the aroma. As they grow about 45 cm, they start giving out the aroma. Growing pumpkin, squash, and beans became problematic. He thought of interposing snake gourd plants anomg pumpkin, squash, and flat bean vines. The vines of other plants got mixed with the snake gourd vines, although not uniformly. To his surprise, he found the leaf-eating and the fruit-eating pests were gone.

The stark difference between the snake gourd vine and other fruit vines is the intense aroma of snake gourd leaves and fruits. Since the snake gourd is grown in summer time, snake gourd leaves and fruits extracts/oils or a synthetic product having the same aroma can be commercially manufactured for uniformly spraying on the pumpkin, squash, and bean vines to drive away pests. Further, the aromanic product can be tested on other fruit vines, fruit and vegetable plants, and fruit trees which bloom in winter or other seasons.

The discovery is using snake gourd fruit plant as the replacement of pesticides for at least pumpkin, squash, and bean plants, and expecting so for some other fruit vines, plants, and trees throughout the year if the plant extract/oil is used. The invention does away with chemical pesticides that are harmful for bees and the environment.

The gist of this invention is that snake gourd leaves and fruits extract/oil or a synthetically prepared chemical having the same intense smell as the snake gourd leaves and fruits can be used to drive away pests, and thus do the work as pesticide. This plant-based pesticide is safe to use without any problem of dermal contact, inhalation, or oral ingestion. This vine fruit has multifarious benefits for humans.

### BRIEF DESCRIPTION OF THE PHOTOGRAPHS

About 60 pests-repellant plants are mentioned in https://en.wikipedia.org/wiki/List_of_pest-repelling_plants. Snake gourd is not there.

The accompanying illustrations show typical specimens of the vegetative growth, flowers, and variety in colors and sizes as true as reasonably possible. Also, the illustrations show the pesticide uses and water resources contamination.

FIG. 1. Whitestripped greenskinned snake gourd in the applicant's garden.

FIG. 2. Whitestripped whiteskinned snake gourd in the applicant's garden.

FIGS. 3 and 4. Mature, ripe yellow colored snake gourd in the applicant's garden.

FIG. 5. The applicant's garden ripe snake gourd dried to take out seed.

FIG. 6. Seeds taken out from inside of a ripe snake gourd from the applicant's garden.

FIG. 7. Baby plant without tendrills in the applicant's garden.

FIG. 8. Vigorously growing plant with tendrills climbing a vertical trellis in the applicant's garden.

FIGS. 9 and 10. Vertically rising vigorously growing snake gourd plant with tendrills in the applicant's garden.

FIG. 11. Snake gourd's heart-shaped leaf in the applicant's garden.

FIG. 12. Snake gourd's 3-lobed leaf in the applicant's garden.

FIG. 13. Snake gourd's 6-lobed leaf in the applicant's garden.

FIG. 14. Snake gourd's 7-lobed leaf, five-petalled white unisexual flowers with long lacy fringes in the applicant's garden.

FIG. 15. Beetles made holes in hyacinth bean plant leaves in the applicant's garden.

FIG. 16. Spotless heart-shaped snake gourd leaves and the three-piece heart-shaped hyacinth flat bean leaves in the applicant's garden.

FIG. 17. Heart-shaped leaf, forked tendrils, and baby snake gourd of white variety, female flower with thick stem in the applicant's garden.

FIG. 18. No pumpkin beetles to lay eggs on the under side of leaves.

FIG. 19. Male flowers borne on short stalks of about equal length at equal distances along an elongated axis (peduncle length 10 to 30 cm) and open in succession toward the apex in the applicant's garden.

FIG. 20. Pumpkin leaves eaten by pumpkim bugs (https:www.shutterstock.com/image-photo/large-pumpkin-leaf-that-has-been-2133979395);

FIG. 21. Aphid-attacked hyacinth beans (http://www.aisekrishi.org/Pests/view/189/%E0%A6%B6_%E0%A6%AE_%E0%A6%B0_%E0%A6%9C_%E0%A6%AC_%E0%A6%AA_%E0%A6%95/language:bn);

FIG. 22. Bugs inside an asia hyacinth flat bean a(http://www.aisekrishi.org/Pests/view/183/%E0%A6%B6_%E0%A6%AE_%E0%A6%B0_%E 0%A6%AB%E0%A6%B2_%E0%A6%9B_%E0%A6%A6_%E0%A6%B0%E0%A6%95_%E0%A6%B0_%E0%A6%AA_%E0%A6%95/language:bn)

FIGS. 23 and 24. Pumpkin and squash bugs (ALMANAC, https://www.almanac.com/pest/squash-bugs);

FIG. 25. Flowering hyacinth bean vine in the applicants garden.

FIGS. 26 and 27. Hyacinth beans free from any pest attack in the applicants garden.

FIG. 28. Sales of pesticide industries (https://nepis.epa.gov/Exe/tiff2png.cgi/300065AN.PNG?-r+150+-g+3+D%3A%5CZYFILES%5CINDEX%20DATA%5C00THRU05%5CTIFF%5C00000683%5 C300065AN.TIF).

FIG. 29. Percentage of time (streams) or samples (ground water) with one or more detections—pesticide in water.

FIG. 30. Percentage of samples with one or more detections—oganochlorine compounds in fish and sediment. https://nepis.epa.gov/Exe/tiff2png.cgi/300065AN.PNG?-r+150+-g+3+D%3A%5CZYFILES%5CINDEX%20DATA%5C00THRU05%5CTIFF%5C00000683%5C300065AN.TIF).

FIG. 31. Percentage of stream sites or wells with one or more pesticides exceeding a human-health benchmark

FIG. 32. Percentage of stream sites with one or more pesticide compounds exceeding an aquatic life benchmark;

FIG. 33. Percentage of stream sites with one or more organochlorine pesticide compounds exceeding a wildlife benchmark 4.8% (https://pubs.usgs.gov/fs/2006/3028/#:˜:text=The%20insecticides%20diazinon%2C%20chlorpyr ifos%2C%20carbaryl,water%20as%20their%20parent%20pesticides

### DETAILED DESERIVTION OF THE INVENTION

Latin name of the plant claimed: Trichosanthes anguina L

Variety: Trichosanthes cucumerina var. anguina (L.) Haines—cultivated variant
Trichosanthes cucumerina var. cucumerina—wild variant

The plants phenotype is determined by both their genomic makeup (genotype) and environmental factors with variations in environmental, climatic, and cultural conditions, as it has not been tested under all possible environmental conditions.

Snake gourd, (Trichosanthes cucumerina), also known as serpent gourd, rapid-growing fruit vine belonging to the gourd family (Cucurbitaceae);

Scientific Classification: Kingdom: Plantae; Division: Magnoliophyta; Class: Mangnoliopsida; Order: Curcubitales; Family: Curcubitaceae; Genus: Trichosanthes; Species: Cucumerina;

Regional Names: Trichosanthes cucumerina is known as Chicinga in Bengali, Chichinda or Padwal in Hindi, Potlakaaya in Telugu, Pudalankaai in Tamil and Padavalanga in Malayalam, potlakaaya in Telugu, pudalankaai in Tamil, aduvalakaay in Indias Karnataks state, padavalanga, in Malayalam, Galartori in Punjabi, padavali in Gujarathi, Chachinda in Hindi; as serpent vegétal in France, Schlangengurke in Germany, Karasu-uri-zoku in Japan, Patola in Srilanka, Zucchetta cinese in Italy, Abobora-serpente in Portugal, Kaarmekurkku in Finland, Buap nguu Ma not in Thailand, Yilan kabagi in Turkey, Calabaza anguina in Spain (Devi, 2017)

Taxonomy: The plants family, predominantly distributed in the tropics, commonly known as melons, gourds or cucurbits that includes cucumbers, squashes (including pumpkins), luffas, melons (including watermelons); one of the most genetically diverse groups of food plant in the plant kingdom; Trichosanthes (100 species), Cayaponia (60 species), Momordica (47 species), Gurania (40 species), Sicyos (40 species) and Cucumis (34 species) major major genera under this family (Devi, 2017).

Biostatistics:0 Two cultivated species Trichosanthes anguina L. and Trichosanthes dioica Roxb.; Important wild species Trichosanthes bracteata (Lam.) Voigt. (Syn. Trichosanthes palmata Roxb.), largely variable Trichosanthes cucumerina L., Trichosanthes lobata, Trichosanthes wallichiana (syn. Trichosanthes multiloba Clarke), Trichosanthes nervifolia L., Trichosanthes cordata Roxb., Trichosanthes japonica and Trichosanthes shikokiana; botanical name Trichosanthes cucumerina L., most common is Trichosanthes anguina L. (Devi, 2017).

Cytology: Trichosanthes chromosomes, n=11 and 2n=22; Trichosanthes bracteate and Trichosanthes cucumeroides n=22 and 2n=44. Tetraploids (2n=44) and hexaploids (2n=66) in Trichosanthes palmate. Induced polyploids in Trichosanthes anguina quadrivalents, trivalents, bivalents and univalent; Only Trichosanthes anguina and Trichosanthes cucumerina monoecious, all others dioecious. Species with 2n-=22 chromosomes metacentric to submetacentric medium-sized (5.74 mm to 1.48 mm) chromosomes; only three pairs of chromosomes with secondary constriction in Trichosanthes anguina and Trichosanthes cucumerina; XY sex chromosomes in Trichosanthes cucumeriodes and Trichosanthes japonica at meiosis and in Trichosanthes multiloba at metaphase. Trichosanthes anguina, Trichosanthes cucumerina and Trichosanthes lobata crossable among themselves with fertile hybrids indicating their close relationship (Devi, 2017).

Seeds: Imbedded in soft red pulp in ripe snake gourd, half-ellipsoid, somewhat compressed, undulate, hard, corrugated, about 1 cm long, about ¾ cm across, greyish-brown, black, sculptured, undulate (FIG. 6).

Seedlings: Seeds planting about 1 m apart at depth about 2.5 cm in well-drained, humus-rich adequate moisture content soil with Ph 6.5-7.0 in sunny locations with at least 6 hrs direct sunlight; tiny and few or no fruits for lesser amount of sunlight; dicotyledonous seedlings with two embryonic leaves in about two weeks in temperature between 80° F. and 95° F. (27° C. to 35° C.); longer timing of weeks for seedlings in lower temperature. For temperatures nearing 100° F. and above, leaves get wilted in the scorching sun.

Plant: Monoecious annual, branchy, slender, green, disagreeable odor, stems up to 5 or 6 meters long, diameter of 5 mm, possibly largest number of fruits producer among all Cucurbitaceae; vigorous growth; climb up vertical supports using tendrils and twining stems to sprawl over its top or the trellises (FIGS. 7-10, FIGS. 1 and 2); plant very variable in the shape of the fruit, some named varieties. traditional cultivars 6 -10 fruits per year, some improved cultivars more fruits per year; garden grown, vegetable, medicinal, and ornamental plant; drought intolerant. Manual weed control required. Watering required to keep the soil humid, no flooding.

Leaves: Base broadly heart-shaped or palmately broad 3, 5, 6, or 7-lobed leaves rounded or obtuse appear, rounded outline, 8 to 12 cm long and broad, sinuses broad or narrow and rounded (FIGS. 11 through 14).

Tendrils: Forked tendrils appearance before the characteristic odor at about 1 m high (FIGS. 8 through 10).

Manure: Periodic application of composted vegetable matter and 13-13-13.

Flowers: (FIGS. 14, 17, 19, 16, 1). Flowering by 1.5 m high, five-petalled white unisexual flowers with long lacy fringes; small, white flowers in bloom day and night; male and female flowers separate; male flowers borne on short stalks of about equal length at equal distances along an elongated axis (peduncle length 10 to 30 cm) and open in succession toward the apex; female ones apart by the long lump on the stem; solitary, sessile, single celled ovary, long and with hairy stigmas.

Pollination: Insects pollinated; manual pollination by snapping off the male flowers and gently rubbing them on the female ones to transfer the pollen; female flower wilting after successful pollination; lump growth on the stem begins to grow; appearances of baby snake gourds; rapid growth (FIGS. 14 and 17).

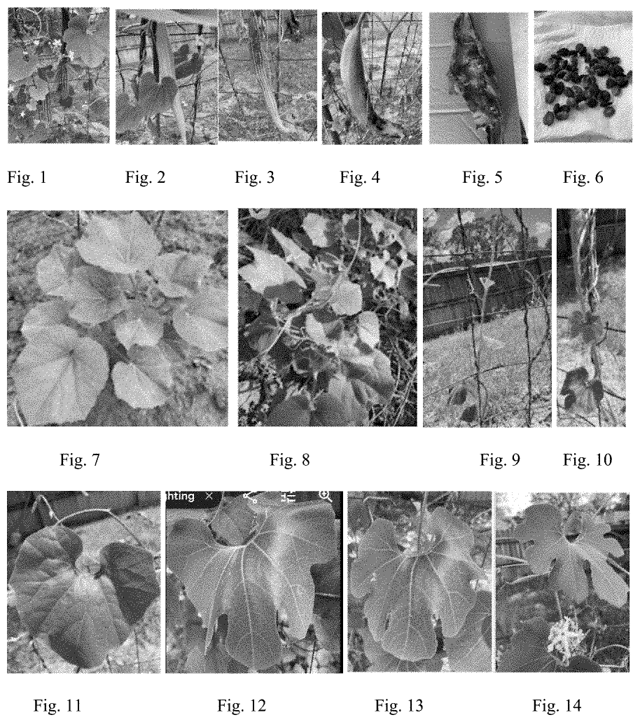

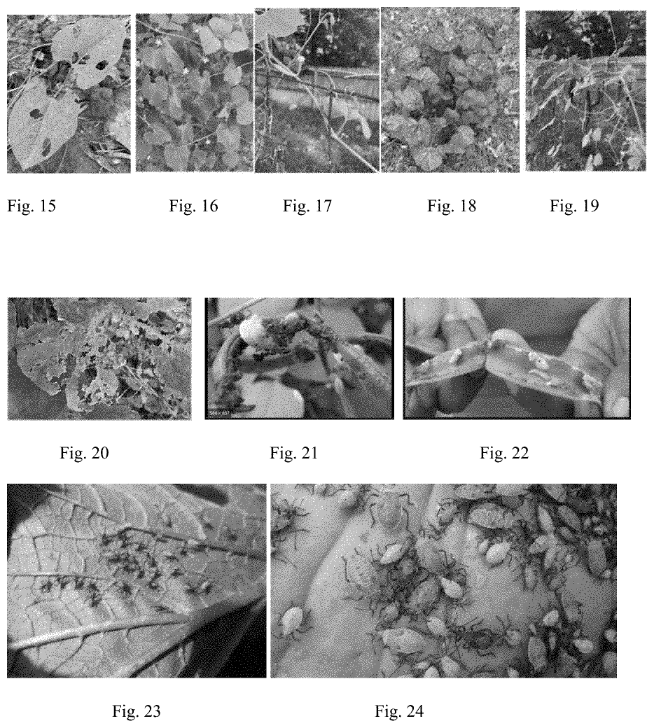

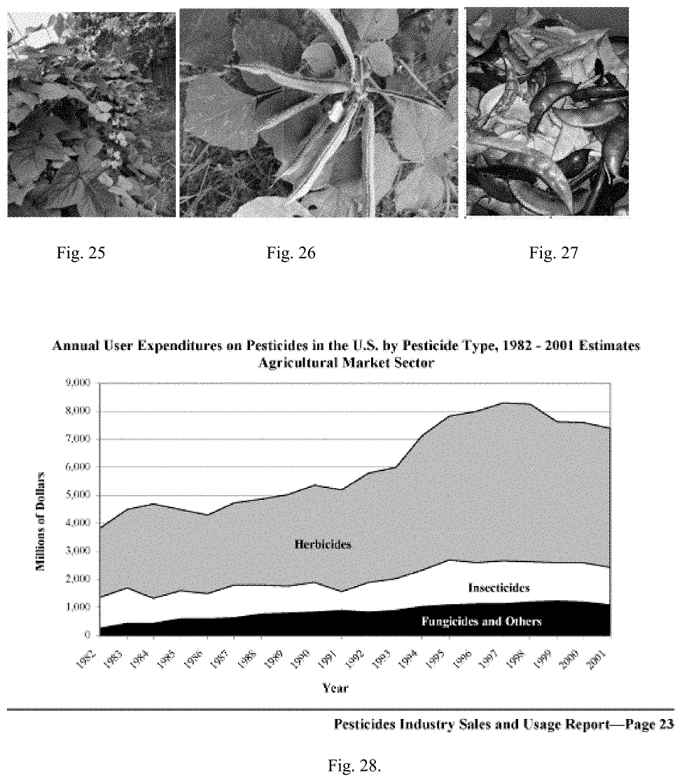

Fruit: Oddly shaped fruits—very slender, long, cylindrical berry, often twisted, green or white when immature, pickable at about 30 cm (FIGS. 1 and 2); immature fruits harvestable about two months after sowing seeds; cropping continues for up to four months or more depending on the weather; delayed picking hardened fruit prior to turning yellowish red (FIGS. 3, 4, and 5); 10 fruits or more per plant; 30 cm mature fruit 5-8 cm middle diameter, thickness, growth dependent weights.

Edible: Young whole fruits cut into pieces for cooking; mature fruits' red, soft sweet testing pulp eaten as a tomato substitute in African countries; bright red pulp around mature seeds extracted for tomato-like cooking.

Pests: The described snake gourds herein resistant to powdery mildew, and repellent to leaf beetles, aphids, snails, slugs, and caterpillars.

Snake Gourd Nutritional Content:

The snake gourd nutrition facts for a 100 g serving are as follows: Calories 86.2 kcal, Macronutrients: Total Fat 3.9 g, Saturated Fat 0.5 g. Total carbohydrate 12.5 g, Dietary Fiber 0.6 g, Protein 2.0 g, Cholesterol 0.0 mg, Sodium 33.0 mg, Potassium 359.1 mg, Vitamins: Vitamin A 9.8%, Vitamin B6 11.3%, Vitamin C 30.5%, Vitamin E 1.1%, Minerals: Calcium 5.1% Magnesium 6.7%, Phosphorus 5.0%, Zinc 7.2%, Iron 5.7%, Manganese 12.5%, and Iodine 5.9% (Bharat, 2022).

Snake Gourd Health Benefits

Accelerates weight loss, augments heart function, detoxifies kidneys, enhances digestive system, strengthens respiratory processes, complements ketogenic diet, soothes depression and anxiety, resolves acid reflux, mitigates Polycystic ovary syndrome (PCOS); seed remedies hypertension, cures diarrhea, manages diabetes symptoms; snake gourd naturally moisturizes skin, combats skin infections, promotes hair growth, tackles excessive dandruff, snake gourd hair gel; in Ayurveda: snake gourd juice baffles fevers, fights jaundice, remedies heart ailments, treats alopecia, recovers joint illnesses, uplifts immunity, regulates thyroid, alleviates insomnia (Bharat, 2022)

National Pesticide Use

The USA uses annually more than one-half billion kg (more than one billion lbs.) of pesticides. The fruit and vegetable growers use the lions share of pesticides per acre (Kiely et al., 2004). In 2012, the US pesticide expenses at the producer level were nearly $9 billion (Pesticides Industry Sales and Usage 2008-2012 Market Estimates in https://www.epa.gov/sites/default/files/2017-01/documents/pesticides-industry-sales-usage-2016_0.pdf). Mechanization, fertilizers, and pesticides involves the primary costs in U.S. food crop production. The inclusion of the irrigation cost raises the total costs 2-3 times higher. When irrigation is employed, the cost is 2 to 3 times the cost of all the other inputs in U.S. food crop production.

Table 2 shows the expenditures on pesticide uses year-wise for two decades ending in 2001, and FIG. 28 shows the sales of pesticide industries during that period (https://nepis.epa.gov/Exe/tiff2png.cgi/300065AN.PNG?-r+150+-g+3+D%3A%5CZYFILES%5CINDEX%20DATA%5C00THRU05%5CTIFF%5C00000683%5C300065AN.TIF).

TABLE 2
Annual expenditures on pesticides uses.
Annual User Expenditure on Pesticides in the U.S. by Pesticide
Type, 1982-2001 Estimates Agricultural Market Sector

| | | | Fungicides | |
|---|---|---|---|---|
| Year | Herbicides/PGR | Insecticides | and Other | Total |
| 1982 | 2,465 | 1,109 | 268 | 3,842 |
| 1983 | 2,800 | 1,261 | 450 | 4,511 |
| 1984 | 3,390 | 903 | 418 | 4,711 |
| 1985 | 2,900 | 990 | 615 | 4,505 |
| 1986 | 2,775 | 914 | 600 | 4,289 |
| 1987 | 2,935 | 1,145 | 650 | 4,730 |
| 1988 | 3,080 | 1,010 | 775 | 4,865 |
| 1989 | 3,255 | 978 | 800 | 5,033 |
| 1990 | 3,463 | 1.067 | 842 | 5,372 |
| 1991 | 3,644 | 687 | 884 | 5,215 |
| 1992 | 3,915 | 1,058 | 829 | 5,802 |
| 1993 | 3,987 | 1,123 | 895 | 6,005 |
| 1994 | 4,808 | 1,293 | 1,036 | 7,137 |
| 1995 | 5,112 | 1,607 | 1,107 | 7,826 |
| 1996 | 5,399 | 1,480 | 1,128 | 8,007 |
| 1997 | 5,610 | 1,551 | 1,124 | 8,285 |
| 1998 | 5,632 | 1,427 | 1,209 | 8,268 |
| 1999 | 5,012 | 1,370 | 1,243 | 7,625 |
| 2000 | 5,007 | 1,411 | 1,194 | 7,612 |
| 2001 | 4,987 | 1,326 | 1,091 | 7,404 |

Note:
Excludes wood preservatives, specialty biocides, and chlorine/hypochlorites
Source: EPA estimates based on Croplife America annual surveys and EPA proprietary data

Snake Gourd Extracts/Oils Pesticides Replacement

Snake gourd effective repellant for pumpkin and squash bugs (pictured in ALMANAC), hyacinth bean bugs and aphids Bean|Diseases and Pests, Description, Uses, Propagation (psu.edu) (Bean|Diseases and Pests, Description, Uses, Propagation (psu.edu)); snake gourd extracts/oils pesticides replacement for sevin, malathion, diazinon, and neonicotinoids (Neonics) used in growing pumpkins, squash, and beans, and keeps water bodies and stream safe. So, environmental savior.

Snake gourd is a summer fruit vine. The Trichosanthes cucumerina vine cannot be used for testing on other fruit vines and trees that bloom in the winter. The only way to test on them is to use the vine leaves and fruits oils/extracts with the aroma intact or a synthetically prepared compound with the same aroma.

Snake Gourd Extracts/Oils Bee Population Savior

Almonds are 100%, and 90% of apples, blueberries, and avocados 90% pollinated by bees. Out of every four bites of food, one bite is bees' contribution. If bees are gone from the agriculture sector, food prices will soar up ten time or more. Many US commercial farms use the pesticides called neonicotinoids (neonics) that have led to mass deaths of these pollinators. Pollen grains contain trace amounts of pesticide. Pollen is carried to beehives for food accumulating it to a critical level within the beeswax. Pesticides affect bees in many ways—their sole chemical and physical signals-based communication, foraging behavior, and their larval development. Further, pesticides lower the bees immune systems, weaken the hive, and leave it wide open to parasitic infection. (https://www.planetbee.org/why-bees-are-dying (https://secure.foodandwaterwatch.org/act/epa-save-bees?gclid=CjwKCAjw9e6SBhB2EiwA5myr9jVUJqntQcQVv4ed3ZTZ5iZHjNxgp0B-JFuQrZhqqYqFXNZQaCSm7BoCO_QQAvD_BwE).

Since the snake guard vines are not harmful to any living beings, bees are not going to be affected.

Snake Gourd Extracts/Oils Reduces Water Resources Contamination

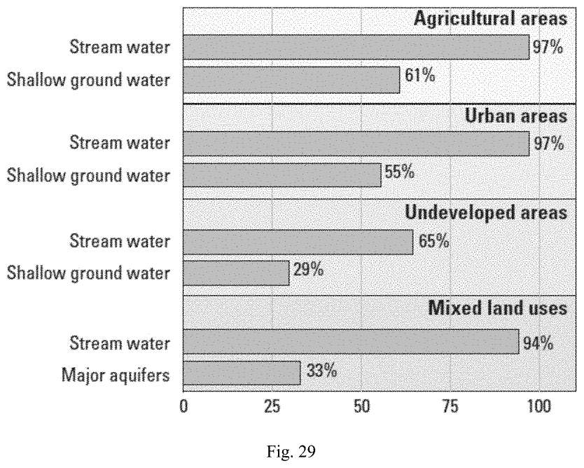

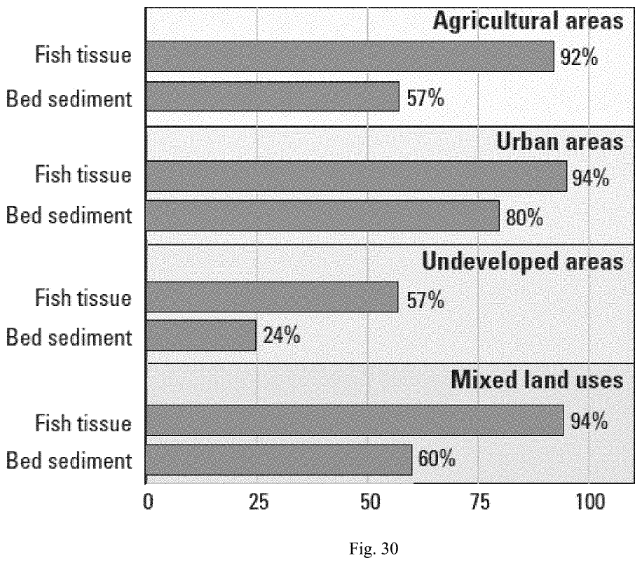

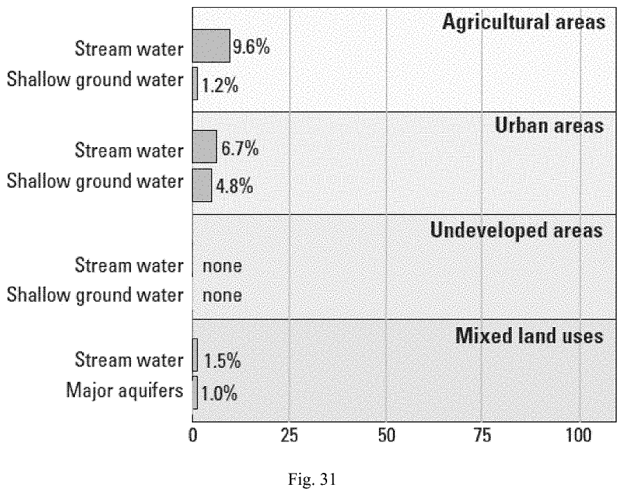

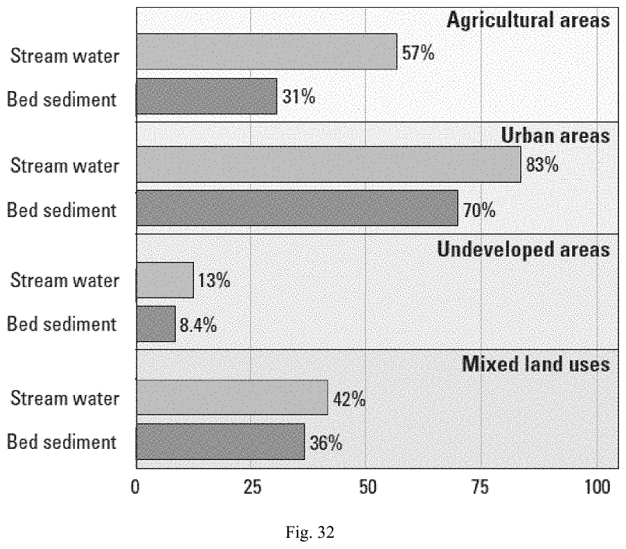

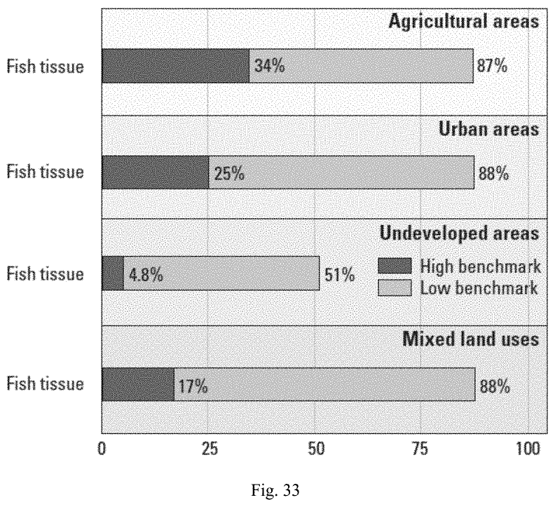

In their fact Fact Sheet “The Quality of Our Nations Waters—Pesticides in the Nation's Streams and Ground Water, 1992-2001.”—USGS highlights national findings on pesticide occurrence, distribution and sources, and the potential for effects on humans, aquatic life, and fish-eating wildlife. Pesticides accumulate in stream-drained watersheds in substantial agricultural or urban areas to a greater level than groundwater (FIGS. 29 and 30). NAWQA's assessment of potential effects is based on comparing measured concentrations to water-quality benchmarks which are estimates of the concentrations above which pesticides may have adverse effects on humans (FIG. 31), aquatic life (FIG. 32), or fish-eating wildlife (FIG. 33). (https://pubs.usgs.gov/fs/2006/3028/#:˜:text=The%20insecticides%20diazinon%2C%20chlorpyr ifos%2C%20carbaryl,water%20as%20their%20parent%20pesticides).

Snake Gourd Extracts/Oils Human-, Aquatics-, and Wildlife-Friendly

Human-health benchmarks were seldom exceeded in ground water. One or more pesticides exceeded a benchmark in about 1 percent of the 2,356 domestic and 364 public-supply wells that were sampled. The greatest proportion of wells with a pesticide concentration greater than a benchmark was for those tapping shallow ground water beneath urban areas (4.8 percent). The urban wells with benchmark exceedances included 1 public-supply, 3 domestic, and 37 observation wells. All concentrations greater than a benchmark were accounted for by dieldrin (72 wells), dinoseb (4), atrazine (4), lindane (2), and diazinon (1). Pesticides typically found in trace levels raise concerns for their potential effects of chronic health problem from long-term use at relatively low concentration.

### REFERENCES

1. Khan, S. M. and Jehangir, M. 2000. Efficacy of different concentrations of sevin dust against red pumpkin beetle (Aulacophora foveicollis (Lucas) causes damage to muskmelon Cucumis melo crop. Pakistan Journal of Biological Science., 3(1): 183-185.
2. Hasan, M. K., Uddin M. M., and Hague, M. A. 2011. EFFICACY OF MALATHION FOR CONTROLLING RED PUMPKIN BEETLE, Aulacophora foveicollis (LUCAS) IN CUCURBITACEOUS VEGETABLES, Progress. Agric. 22(1 & 2): 11-18, 2011 ISSN 1017-8139
3. OC Pest Management Guidelines, available in (http://ipm.ucanr.edu/PMG/r116301111.html
4. Smart Gardener, Plant Guide available in https://www.smartgardener.com/plants/6865-bean-specialty-hyacinth—lablab-purpureus/pests/538-aphidsFig.
5. Gill. R. J. and Raine. N. E. Chronic impairment of bumblebee natural foraging behavior induced by sublethal pesticide exposure. Functional Ecology, 2014; DOI: 10.1111/1365-2435.12292.
6. Stackpoole, S. M., Shoda, M. E., Medalie. L., Stone, W. W. 2017. Pesticides in US Rivers: Regional differences in use, occurrence, and environmental toxicity, 2013 to 2017, Science of The Total Environment, Volume 787, 15 Sep. 2021, 147147 https://doi.org/10.1016/j.scitotenv.2021.147147
7. Bharat. D. 2022. Snake Gourd: Health Benefits, Nutrition, Uses For Skin And Hair, Recipes, Side Effects, available from https://www.netmeds.com/health-library/post/snake-gourd-health-benefits-nutrition-uses-for-skin-and-hair-recipes-side-effects
8. Devi, N. D. 2017. Medicinal Values of Trichosanthus cucumerina L. (Snake Gourd)—A Review, British Journal of Pharmaceutical Research, 16(5): 1-10, 2017; Article no.BJPR.3357, ISSN: 2231-2919, NLM ID: 10163175

1. A new and distinct variety of fruit vine of the Cucurbitaceae class (Trichosanthes anguina L.), substantially as herein shown and described, characterized by intense aroma, rapid growth; tender stems, forked tendrils, heart-shaped or palmately broad green leaves, and five-petalled, long lacy fringed white unisexual day-night open flowers; oddly shaped waxy green or white skinned fruits; major fungal, bacterial, viral diseases resistant; aphids, insects, beetles (Cerotoma trifurcata) repellant from pumpkin, squash, and bean plants if the said vine is interposed among these target vines (U.S. patent application Ser. No. 17/942,119). The plant replaces bee-killing, water resources-polluting, and humans-, aquatics-, and wildlife-endangering pesticides like Sevin, Malathion, Diazinon, and Neonicotinoids (Neonics); also, eliminates manual killing of pests. Claimed commercial use of the
1. Characteristic aroma-containing plant extract/oil can be uniformly sprayed upon the said target plants and on other potential target plants, vegetables, and fruit trees throughout the year.
2. Synthetically prepared the same aromatic product can be used for the same purpose as in #1 above.
